(19) United States
(12) Patent Application Publication
(10) Pub. No.: US 2006/0103234 A1
(43) Pub. Date: May 18, 2006

(54) Automatic control system for parking brake of automobile

(76) Inventor: Bo Moon Jeong, Gyeongsangbuk-do (RU)

Correspondence Address: LADAS & PARRY LLP, 224 SOUTH MICHIGAN AVENUE, SUITE 1600, CHICAGO, IL, 60604, US

(21) Appl. No.: 10/523,433

(22) PCT Filed: Jul. 28, 2003
(86) PCT No.: PCT/KR03/01508

§ 371 Date: Mar. 7, 2005

(30) Foreign Application Priority Data
Jul. 29, 2002 (KR) 20-2202-0023239

(51) Int. Cl. B60T 13/66

(52) U.S. Cl. 303/89; 303/20

(57) ABSTRACT

An automatic control system for parking brake of an automobile according to the invention has an oil pipe (13) connecting a brake master cylinder (1) with a wheel cylinder (2). The brake system comprises a selection switch (9) switching to AUTO mode or SEMI/AUTO mode for a braking mode, a solenoid check valve (3) installed between an oil outlet (1a) of the brake master cylinder (1) and the oil pipe (13), a relay (4) controlled by a stop sensing sensor (6) by way of ON/OFF, and a stop sensing sensor circuit. Upon stepping on a brake pedal, the main brake is operated during traveling, whereas the parking brake is operated by the main brake without operating the parking brake in the status of stopping by controlling the solenoid check valve by way of free flow or control flow with the selection switch.

### TECHNICAL FIELD

This invention relates to an automatic control system for a parking brake of an automobile, and more particularly to an automatic control system for a parking brake for providing all 4 wheels of the automobile with a powerful brake force without a separate parking brake device by installing a control system controlling flow of a brake oil in one end of a brake master cylinder.

### BACKGROUND ART

Generally, a brake device of an automobile has a main brake for using during traveling and a parking brake for keeping parking.

A prior brake device is divided into a main brake and a parking brake, and the parking brake is operated to only 2 wheels. Thus, a parking brake force is not powerful. Accordingly, there have been some problems in that, in case of parking using only the parking brake in a slope, the parking is done in the status of shifting a gear (forward or backward) or the wheel is choked using a stone or a brick so that the automobile may not be skidded.

Further, there have been some problems in that, in the case of intending to drive without releasing the parking brake, it leads to rapid abrasion of a brake lining or a serious damage of the brake device, and a manipulation of the parking brake must be done by an operation of one step.

It is an object of the invention to provide a brake system of an automobile providing a parking brake device having the brake force equal to the brake force of a main brake.

Another object of the invention is to provide an automatic brake system for providing temporary brake operation during traveling or continuous brake operation in the status of stopping by sensing automatically the traveling status or the stopping status even if the brake device is driven by the same method as the manipulation of the main brake. A further object of the invention is to provide an automatic brake system for automatically releasing a brake operation of a brake and changing to the traveling status by driving simply an accelerator without a special manipulation for changing the brake status to the traveling status upon stopping.

### DISCLOSURE OF THE INVENTION

According to the invention, the brake force of the parking brake is equal to that of the main brake by providing in series the brake operation even with the same manipulation of a driver by connecting a main brake with a parking brake, and temporary or continuous brake operation of the brake system is automatically made by sensing of itself the status of traveling or stopping. Further, when traveling is started after stopping, the brake status of the brake system is automatically released.

### BRIEF DESCRIPTION OF THE DRAWINGS

FIG. 1 is a view for showing a circuit of an automatic control system for a parking brake according to a preferred embodiment of the invention;

FIG. 2 is a diagram for showing an operation of an automatic control system for a parking brake according to a preferred embodiment of the invention; and

FIG. 3 is a flow chart for showing an operation of an automatic control system for a parking brake according to a preferred embodiment of the invention.

### BEST MODE FOR CARRYING OUT THE INVENTION

The invention will be described in further detail by way of example with reference to the accompanying drawings.

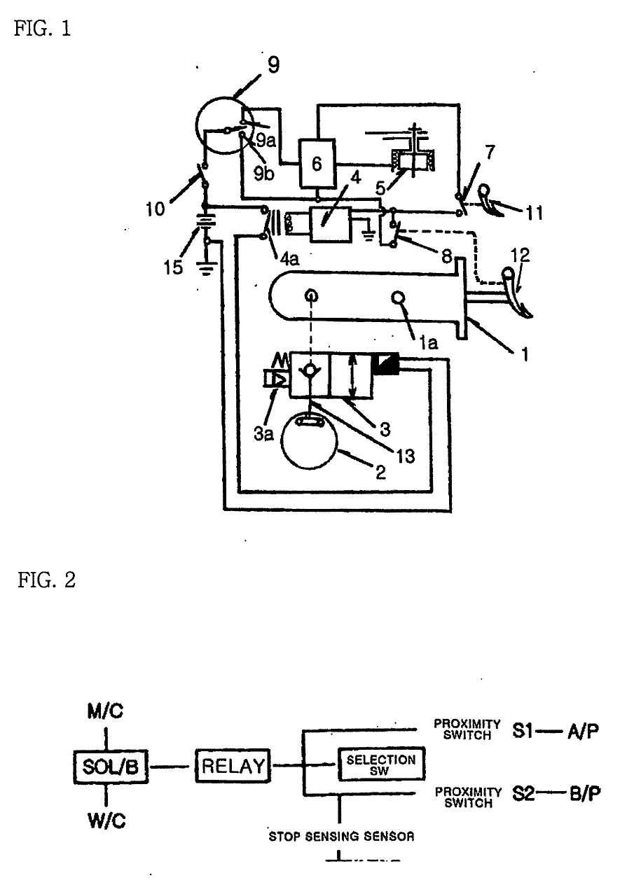

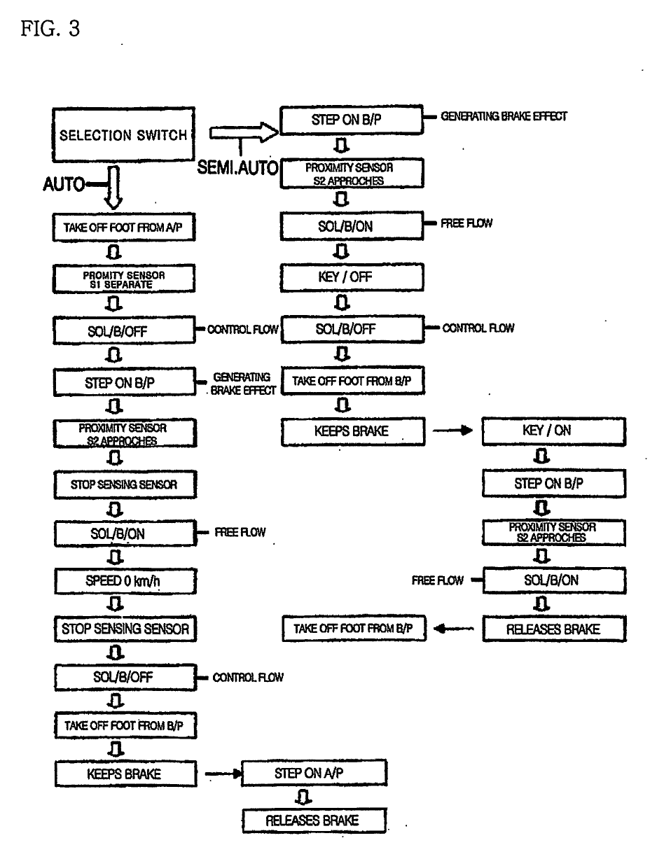

According to the preferred embodiment of the invention as shown in FIGS. 1 to 3, a brake system for an automobile has an oil pipe 13 connecting a brake master cylinder 1 with a wheel cylinder 2. The brake system comprises a selection switch 9 switching to AUTO mode or SEMI/AUTO mode for a braking mode by having an AUTO mode terminal 9a automatically controlling a main brake and a parking brake and a SEMI/AUTO mode terminal 9b actuating the main brake during traveling or the parking brake upon the status of KEY-OFF, a solenoid check valve 3 installed between an oil outlet 1a of the brake master cylinder 1 and the oil pipe 13, having a plus electrode thereof connected to a plus electrode of a battery by being connected to a relay proximity switch 4a, and actuated by an ON/OFF type control of relay 4, a relay 4 controlled by a stop sensing sensor 6 by way of ON/OFF according to whether or not a proximity switch S1 7 installed in a accelerate pedal 11 and a proximity switch S2 8 installed in a brake pedal 12 contact and a detect signal from a speed sensor 5 sensing the speed of the automobile, and a stop sensing sensor circuit connected in series to a proximity switch S2 8 installed in a brake pedal 12 by connecting in series an AUTO mode terminal 9a of the selection switch 9 connected to an output terminal of KEY switch 10 with the proximity switch S2 8 connected to a power source of the relay 4 and connecting in parallel SEMI/AUTO mode terminal 9b with the stop sensing sensor 6 output terminal.

Further, according to a driver's selection of AUTO mode terminal 9a or SEMI/AUTO mode terminal 9a from the selection switch 9, the relay 4 controlled by the stop sensing sensor 6, the proximity switch S1 6 and the proximity switch S2 8 controls the solenoid check valve 3 installed between the oil pipe 13 and the oil inlet 1a of the brake master cylinder 1 by way of free flow or control flow. Therefore, upon stepping on a brake pedal 12, the main brake is operated during traveling, whereas the parking brake is operated by the main brake without operating the parking brake in the status of stopping (that is, at speed of 0 km/hour).

According to the invention, if a driver steps on a brake pedal in the status of AUTO mode of the selection switch 9 upon traveling, a brake effect is generated. At a speed of more than 0 km/hour, the solenoid check valve 3 has an brake effect generated by the brake pressure enough to step on the pedal in the status of free flow.

Then, if a driver takes off his foot from the pedal before the automobile is stopped, an oil pressure conveyed to the wheel cylinder 2 is returned to the brake master cylinder 1 and a general operation of the main brake is prosecuted.

If an automobile is stopped by generating a brake effect by stepping on the pedal during traveling, at a speed of 0 Km/h, the solenoid valve 3 maintains the brake pressure in the status of control flow even if the driver takes off his foot from the pedal, and thus the parking brake operation is prosecuted.

If the driver steps on the accelerator pedal 11 to start again, the relay 4 is actuated by the proximity switch S1 7, and the solenoid is actuated by the contact of the relay. As a result, the solenoid check valve 3 is on the status of free flow, and an oil pressure conveyed to the wheel cylinder 2 returns to the master cylinder 3. Therefore, the brake is released, and the traveling is started.

Further, without considering the speed of the automobile in the SEMI/AUTO mode 9b of the selection switch 9, when the KEY switch is ON, only the main brake is operated. However, when the KEY switch is OFF, if the brake pedal 12 is stepped on, the brake status is maintained, and thus the parking brake is operated. A reference number “15” if FIG. 1 designates an electric power of a battery.

The other feature of the invention shows that a safety is ensured to be possible to brake under any conditions by substituting the solenoid valve, which is a core element of the system, for a check valve.

### INDUSTRIAL APPLICABILITY

From the foregoing, the brake system according to the invention controls flow of oil pressure between the brake master cylinder and the wheel cylinder with free flow and control flow by controlling the sensor receiving the signal of the car speed sensor and sensing the stopping status, and the signals showing whether or not the accelerator pedal or the brake pedal is operated.

The system automatically controls the main brake during traveling or the parking brake upon stopping without manipulating specially the parking brake, and thus the convenience of the manipulation is obtained. Further, the system provides all 4 wheels with parking brake force. Thus, the safety for parking brake is improved, and a climbing start and a sudden start of the automobile of the automatic transmission is prevented.

Further, the driver may feel a convenient effect, since there is no need to step on the pedal continuously upon stand-by to traffic signals or upon stopping and parking.

What is claimes is:

1. An automatic control system for a parking brake of an automobile having an oil pipe 13 connecting a brake master cylinder 1 with a wheel cylinder 2, the system comprising:
a selection switch 9 switching to AUTO mode or SEMI/AUTO mode for a braking mode by having an AUTO mode terminal 9a automatically controlling a main brake and a parking brake and a SEMI/AUTO mode terminal 9b actuating the main brake during traveling or the parking brake upon the status of KEY-OFF;
a solenoid check valve 3 installed between an oil outlet 1a of the brake master cylinder 1 and the oil pipe 13, having a plus electrode thereof connected to a plus electrode of a battery by being connected to a relay proximity switch 4a, and actuated by an ON/OFF type control of relay 4;
a relay 4 controlled by a stop sensing sensor 6 by way of ON/OFF according to whether or not a proximity switch S1 7 installed in a accelerate pedal 11 and a proximity switch S2 8 installed in a brake pedal 12 contact and a detect signal from a speed sensor 5 sensing the speed of the automobile; and
a stop sensing sensor circuit connected in series to a proximity switch S2 8 installed in a brake pedal 12 by connecting in series an AUTO mode terminal 9a of the selection switch 9 connected to an output terminal of KEY switch 10 with the proximity switch S2 8 connected to a power source of the relay 4 and connecting in parallel SEMI/AUTO mode terminal 9b with the stop sensing sensor 6 output terminal;
according to a driver's selection of AUTO mode terminal 9a or SEMI/AUTO mode terminal 9a from the selection switch 9, the relay 4 controlled by the stop sensing sensor 6, the proximity switch S1 6 and the proximity switch S2 8 controlling the solenoid check valve 3 installed between the oil pipe 13 and the oil inlet 1a of the brake master cylinder 1 by way of free flow or control flow;
whereby, upon stepping on a brake pedal 12, the main brake being operated during traveling, whereas the parking brake being operated by the main brake without operating the parking brake in the status of stopping.

2. The system according to claim 1, wherein, when an electric power is OFF, reverse flow control is effected so that an oil pressure conveyed from the brake master cylinder 1 to the wheel cylinder 2 may not return to the brake master cylinder 1, whereas, when the electric power is ON, free flow of the oil pressure is effected so that the oil pressure conveyed to the wheel cylinder 2 may return to the brake master cylinder 1, and the solenoid check valve 3 includes a manual operating button 3a.

3. The system according to claim 1, wherein the selection switch 9 includes an AUTO mode terminal 9a for automatically controlling the main brake and the parking brake by way of selection and a SEMI/AUTO mode terminal 9b actuating the parking brake only when the KEY switch is OFF.
